(19) United States
(12) Patent Application Publication
(10) Pub. No.: US 2018/0245761 A1
(43) Pub. Date: Aug. 30, 2018

(54) ILLUMINATION DEVICE, ILLUMINATION SYSTEM, AND MOVABLE BODY

(71) Applicant: PANASONIC INTELLECTUAL PROPERTY MANAGEMENT CO., LTD., Osaka (JP)

(72) Inventors: Hiroya TSUJI, Kyoto (JP); Yoshihiko KANAYAMA, Hyogo (JP); Yasuharu UENO, Osaka (JP); Tomoyuki OGATA, Osaka (JP)

(73) Assignee: PANASONIC INTELLECTUAL PROPERTY MANAGEMENT CO., LTD., Osaka (JP)

(21) Appl. No.: 15/903,639

(22) Filed: Feb. 23, 2018

(30) Foreign Application Priority Data
Feb. 27, 2017 (JP) 2017-035215

(51) Int. Cl. F21S 41/20; F21S 41/255; B60Q 1/14; F21S 41/143

(52) U.S. Cl. CPC F21S 41/285; F21S 41/255; F21Y 2113/17; F21S 41/143; B60Q 1/1415

(57) ABSTRACT

An illumination device, an illumination system, and a movable body are provided in which color toning can be easily realized in a particular region, and toning unevenness can be suppressed. A headlight includes an LED substrate in which a plurality of light sources are mounted on a substrate, a primary lens provided at a light emission side of the plurality of light sources, and a projector lens provided at an opposite side from the side of the plurality of light sources with respect to the primary lens. The plurality of light sources include a plurality of group light sources each including a first white color LED which emits light of a bright white color, and a second white color LED which emits light of a natural white color.

### CROSS REFERENCE TO RELATED APPLICATION

The disclosure of Japanese Patent Application No. 2017-035215 filed on Feb. 27, 2017, including the specification, claims, drawings, and abstract, is incorporated herein by reference in its entirety.

### TECHNICAL FIELD

The present disclosure relates to an illumination device, an illumination system, and a movable body.

### BACKGROUND

In the related art, there is known a headlight of a vehicle as described in JP 2009-224191 A. In this headlight, a plurality of light emitting elements are mounted on one substrate, and the plurality of light emitting elements emit light of the same color. In this headlight, brightness of a light emitting element mounted in a first region of the substrate is controlled independently from that of a light emitting element mounted in a second region of the substrate. In this manner, there is enabled light distribution control that is more flexible than a binary light distribution control including a light distribution pattern for low beam and a light distribution pattern for high beam.

If it becomes easier to tone colors at a particular region in an illumination region and to suppress toning unevenness, it becomes possible to illuminate a target to which attention should be directed and dark locations in a standing manner from the other regions during driving of the vehicle. Thus, accidents can be reduced, giving the control a significant meaning.

An advantage of the present disclosure lies in provision of an illumination device, an illumination system, and a movable body in which color toning can be easily realized in a particular region forming at least a part of the illumination region, and toning unevenness can be suppressed.

### SUMMARY

According to one aspect of the present disclosure, there is provided an illumination device comprising: a light source substrate in which a plurality of light sources are mounted on a substrate; a substrate on which a plurality of light sources are mounted; a light guide provided at a light emission side of the plurality of light sources; and a projector lens provided at a side opposite of the substrate with respect to the light guide, wherein the plurality of light sources includes one or more group light sources each including a first light color emitting element and a second light color emitting element, the light guide includes one or more light guide combiners, each of which includes a light incidence surface provided at a light emission side of the group light source and a light exit surface provided at an end on a side opposite from the light incidence surface, and each of which guides the lights of the plurality of colors in a manner to allow combining of the lights, and a first color light emission region of the light exit surface from which light of a first color is emitted and a second color light emission region of the light exit surface from which light of a second color is emitted overlap each other. In the present specification, lights of different colors are defined as lights which differ in distribution shapes of the spectrum.

### ADVANTAGEOUS EFFECTS OF INVENTION

According to the illumination device, the illumination system, and the movable body of the present disclosure, it becomes possible to easily realize toning at a particular region forming at least a part of the illumination region, and to suppress color toning unevenness.

### BRIEF DESCRIPTION OF DRAWINGS

Embodiment(s) of the present disclosure will be described by reference to the following figures, wherein:

FIG. 1 is a plan view showing an automobile according to an embodiment of the present disclosure, viewed from a front side;

FIG. 2 is a partial cross-sectional diagram of a headlight of the automobile;

FIG. 3 is an exploded perspective diagram of a light source substrate, a light guide, and a projector lens when the headlight is disassembled;

FIG. 4 is a control block diagram of a headlight system including the headlight;

FIG. 5A is a plan view showing the light exit surface of the light guide;

FIG. 5B is a plan view showing the light incidence surface of the light guide;

FIG. 5C is a plan view showing the light emission surface of the light source substrate;

FIG. 6A is a diagram showing the chromaticity distribution viewed from a driver seat when all second white color LEDs included in a light source substrate are lighted;

FIG. 6B is a diagram showing the chromaticity distribution viewed from the driver seat when all first and second white color LEDs included in the light source substrate are lighted;

FIG. 7 is a diagram showing a front side of the automobile as viewed from a driver's seat, for explaining a reason why accidents can be suppressed in the automobile;

FIG. 8A is a plan view showing the light incidence surface of the light guide;

FIG. 8B is a plan view of the light emission surface of the light source substrate;

FIG. 9A shows the chromaticity distribution as viewed from a driver's seat when all second white color LEDs included in the light source substrate are lighted;

FIG. 9B shows the chromaticity distribution as viewed from the driver's seat when all second white color LEDs and one first white color LED included in the light source substrate are lighted;

FIG. 9C shows the chromaticity distribution as viewed from the driver's seat when all second white color LEDs and first white color LEDs positioned at a periphery of the light source substrate are lighted;

FIG. 10A is a diagram for explaining a desirable relative position of a light exit surface of a primary lens with respect to a focusing surface of a projector lens; and

FIG. 10B is a diagram for explaining a desirable relative position of a light exit surface of a primary lens with respect to a focusing surface of a projector lens.

### DESCRIPTION OF EMBODIMENTS

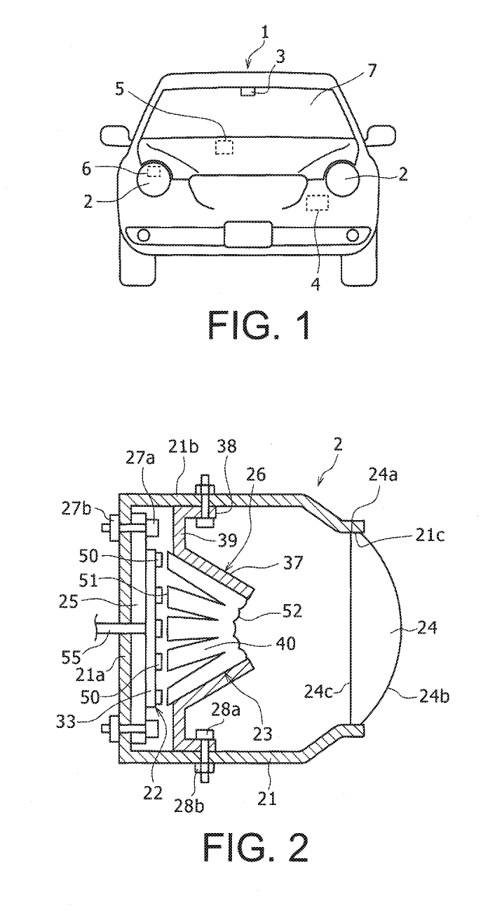

An embodiment of the present disclosure will now be described in detail with reference to the accompanying diagrams. In the following description, when a plurality of embodiments and a plurality of alternative configurations are included, a new embodiment suitably combining the characteristic portions of these is also conceived of FIG. 1 is a plan view when an automobile 1 related to an embodiment of the present disclosure is viewed from a front side. As shown in FIG. 1, the automobile 1 comprises a headlight 2, a camera 3 which is an example of a human-sensing sensor, a battery 4, a biometric information inputter 5, and a controller 6. The headlight 2 is placed on respective sides in a width direction at the front end of the automobile 1. The camera 3 is attached, for example, between a windshield 7 and a rearview mirror (not shown) in a passenger compartment and at an inner side and upper side of the windshield 7. The battery 4 is equipped in an engine compartment. The biometric information inputter 5 is placed on an instrument panel (not shown) or the like. The instrument panel is a front panel on which a monitor of a navigation system, a monitor for an audio system, or the like is placed. A driver of the automobile 1 can input age, presence or absence of cataract, and stage of the cataract, using the biometric information inputter 5.

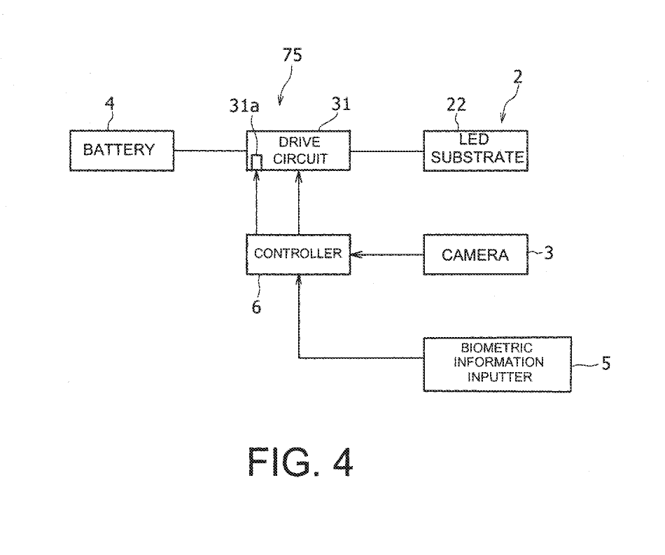

The controller 6 may be placed in a casing of the headlight 2, or outside of the casing such as, for example, inside an instrument (not shown). The instrument is a front side equipment chamber in which the navigation system, the audio system, an air bag of the passenger seat, or the like are stored. When the controller 6 is placed outside of the casing of the headlight 2, the controller 6 may be formed as a part of a controller which comprehensively controls the vehicle 1. The controller 6 receives a signal from the camera 3, and a signal from the biometric information inputter 5. The controller 6 also outputs a signal to the headlight 2, to control light distribution and color toning of the headlight 2. The light distribution and the color toning controls can be executed based on a signal from the camera 3, and are executed based on a biometric signal when the biometric signal is input from the biometric information inputter 5. With the light distribution and color toning controls, electric power based on the controls is supplied from the battery 4 to the headlight 2, and the headlight 2 emits light according to the controls. The light distribution and color toning controls will be described later in detail with reference to FIG. 4, and subsequent drawings.

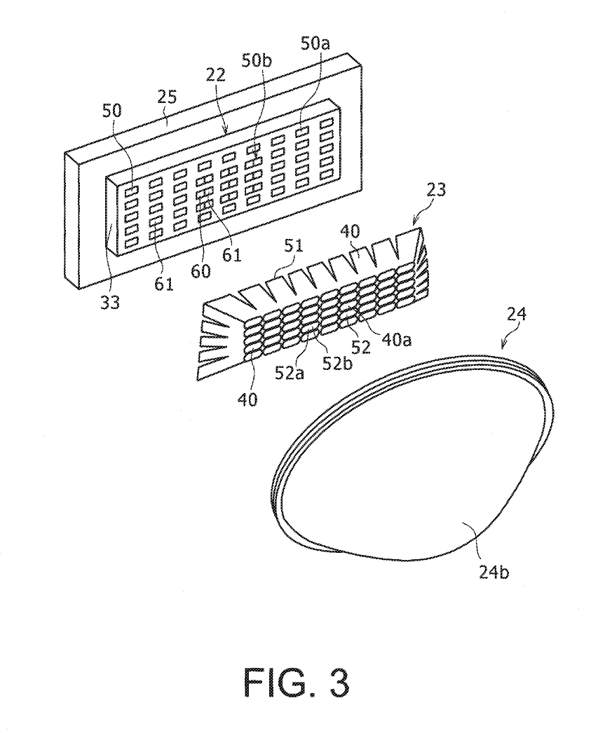

FIG. 2 is a partial cross-sectional diagram of the headlight 2, and FIG. 3 is an exploded perspective diagram of an LED substrate 22, a primary lens 23, and a projector lens 24, in a state where the headlight 2 is disassembled. A structure of the headlight 2 will now be briefly described with reference to FIGS. 2 and 3.

As shown in FIG. 2, the headlight 2 comprises the LED substrate 22, which is an example of a light source substrate, the primary lens 23, serving as a light guide, and the projector lens 24. The LED substrate 22 and the primary lens 23 are placed in a casing 21, and the projector lens 24 is attached on the casing 21. The LED substrate 22 comprises a substrate 33, and a plurality of light sources 50 mounted on a front side (side of the projector lens 24) of the substrate 33, with a spacing between the light sources. The LED substrate 22 is fixed on a substrate attachment plate 25 by a fixation means such as, for example, a fastener member, an adhesive, or the like. The substrate attachment plate 25 is attached, for example, to a flat plate unit 21a forming a bottom of the casing 21 by a fixation means such as, for example a bolt 27a and a nut 27b. Each light source 50 is formed from one or more light emitting diodes (hereinafter referred to as “LEDs”). The structure of the light source 50 will be described later. A cable 55 for supplying electric power to the light source 50 is electrically connected to the LED substrate 22. The cable 55 passes, for example, through a through hole formed on the substrate attachment plate 25 and a through hole formed at the bottom of the casing, and extends from the inside of the casing to the outside of the casing.

The primary lens 23 is placed on a light emission side of the plurality of light sources 50. The primary lens 23 has a plurality of light guides 40, in the same number as the light sources 50, and each light guide 40 includes a light incidence surface 51 placed on the light emission side of the light source 50 and a light exit surface 52 placed at an end opposite from the light incidence surface 51. The plurality of light guides 40 correspond in a one-to-one relationship to the plurality of light sources 50, and each light guide 40 guides the light from the corresponding light source 50 from the light incidence surface 51 to the light exit surface 52. A periphery portion of an end of each light guide 40 on the light exit surface side is joined with a periphery portion of an end of an adjacent light guide 40 at the light exit surface side. As a result, the plurality of light guides 40 are integrated, and the integral primary lens 23 is formed.

The primary lens 23 is fixed, for example, on a casing side wall 21b by a primary fixation member 26. The primary fixation member 26 comprises, for example, an annular portion 37 which contacts the sides of the primary lens 23 over the entire circumference thereof, to constrain the sides, a plate-shaped attachment portion 38 having an attachment surface corresponding to an inner side surface of the casing side wall 21b, and a connection portion 39 which connects the annular portion 37 and the attachment portion 38. With the attachment portion 38 being attached to the casing side wall 21b by a fixation means such as, for example, a bolt 28a and a nut 28b, the primary lens 23 is fixed on the casing 21.

The projector lens 24 is placed at an opposite side from the side of the light source 50 with respect to the light exit surface 52 of the primary lens 23. A surface of the projector lens 24 on the light exit side is formed from a convex surface 24b, and the surface of the projector lens 24 on the incidence side is formed from a flat surface 24c. The casing 21 has one side in an axial direction (direction normal to the bottom surface of the bottom) opened, and an edge on the one side has a tubular inner circumferential surface 21c. An edge 24a of the projector lens 24 is fixed on the tubular inner circumferential surface 21c.

As shown in FIG. 3, the plurality of light sources 50 are mounted on a front side of the substrate 33 in a matrix form. The plurality of light sources 50 include a single light source 50a formed from only one LED, and a group light source 50b formed from two LEDs. The LED is one example of a light emitting element. In the example configuration of FIG. 3, the plurality of light sources 50 are placed in 5 rows and 9 columns, with the group light sources 50b being placed in a central portion in 3 rows and 3 columns and the single light sources 50a placed at other locations. The group light source 50b includes a first white color LED 60 which emits light of a bright white color having a color temperature of around 8000K, and a second white color LED 61 which emits light of natural white color having a color temperature of around 5000K. On the other hand, the single light source 50a includes only the second white color LED 61. The first white color LED 60 is one example of a first light color emitting element, and the second white color LED 61 is one example of a second light color emitting element. The light of the bright white color is one example of light of a first color, and the light of the natural white color is one example of light of a second color.

It is known that, when the environment becomes dark, sensitivity of the human eye is increased, and the light which can be easily seen by humans is shifted toward a short wavelength side. The bright white color includes a large portion of light near a wavelength of 507 nm in which the sensitivity of the eye for the light is at a peak in a slightly dark environment such as that where a security light is placed, and can show the illuminated region brightly and standing from the other regions.

The primary lens 23 has the light guides 40 in the same number as the light sources 50. The light from each light source 50 is incident on the light incidence surface 51 of the light guide 40 corresponding to the light source 50, and is emitted from the light exit surface 52 of the corresponding light guide 40. The plurality of light exit surfaces 52 of the primary lens 23 are placed in a matrix form of 5 rows and 9 columns, corresponding to the placement of the plurality of light sources 50. Because the plurality of light sources 50 and the plurality of light guides 40 correspond in the one-to-one relationship, the light of the bright white color and the light of the natural white color emitted from the same group light source 50b pass the same light guide 40. Therefore, when the light of the bright white color and the light of the natural white color are emitted from the same group light source 50b to the corresponding light guide 40, the light of the bright white color and the light of the natural white color are combined at the light guide 40. The nine group light sources 50b placed in 3 rows and 3 columns on the substrate 33 correspond to the light guides 40 placed at the central portion of the primary lens 23 in 3 rows and 3 columns. Each of the light guides 40 placed in the 3 rows and 3 columns forms a light guide combiner 40a which guides the lights of two colors from the group light source 50b in a manner to allow combining of the lights.

When the light of the bright white color is emitted from the group light source 50b, the light of the bright white color is emitted from a first color light emission region 52a of the light exit surface 52 of the corresponding light guide combiner 40a. Moreover, when the light of the natural white color is emitted from the same group light source 50b, the light of the natural white color is emitted from a second color light emission region 52b of the light exit surface 52 of the corresponding light guide combiner 40a. The first color light emission region 52a and the second color light emission region 52b have portions which overlap each other.

The light emitted from each light source 50 passes through the corresponding light guide 40 and is emitted from the light exit surface 52 of the light guide 40. The light emitted from the light exit surface 52 of each light guide 40 is incident on the projector lens 24. As described above, the projector lens 24 has the convex surface 24b at a side opposite from the side of the LED substrate 22. The light incident on the projector lens 24 is emitted to the outside from the convex surface 24b of the projector lens 24.

Alternatively, unlike the example configuration of FIG. 3, the plurality of light sources and the light exit surfaces of the primary lens may be placed in N rows and M columns (wherein N and M are arbitrary natural numbers), and at least one light source may include one or more semiconductor laser elements which are examples of other light emitting elements. Further, it is sufficient that the plurality of light sources include at least one group light source. Moreover, one or more group light sources may include three or more light emitting elements, and may be able to emit lights of three or more colors which differ from each other. In addition, a case is described in which the first color is the bright white color and the second color is the natural white color.

Alternatively, the first color and the second color may be selected from among an incandescent color, a warm white color, a white color, the natural white color, a daylight color, and the bright white color, in a manner to differ from each other. The color temperature for the incandescent color is around 3000K, the color temperature for the warm white color is around 3500K, the color temperature for the white color is around 4200K, the color temperature for the natural white color is around 5000K, the color temperature for the daylight color is around 6500K, and the color temperature for the bright white color is around 8000K. Alternatively, one or more group light sources may be able to emit one or more lights of colors different from white.

Next, control related to the headlight 2 in the automobile 1 will be described with reference to FIG. 4, which is a control block diagram of a headlight system 75 including the headlight 2. With reference to FIG. 4, the headlight system 75 is an example of an illumination system, and includes the headlight 2, the camera 3, the battery 4, the biometric information inputter 5, and the controller 6. In the headlight system 75, the signals from the camera 3 and the biometric information inputter 5 are input to the controller 6. The headlight 2 comprises a drive circuit 31 in addition to the LED substrate 22. The drive circuit 31 is electrically connected to the battery 4. The drive circuit 31 has, for example, 54 switching units corresponding respectively to 54 (5×9+3×3) first and second white color LEDs 60 and 61 of the headlight 2, and the controller 6 controls the switching ON and OFF of the 54 switching units independently from each other. Each switching unit is formed from, for example, a transistor or the like. A voltage is applied from the battery 4 to the white color LEDs 60 and 61 corresponding to the switching unit which is controlled to be switched ON by the controller 6, and light is emitted from the white color LEDs 60 and 61. The drive circuit 31 further comprises a transformer circuit 31a including a plurality of switching units. Based on signals from the controller 6 to the switching units of the transformer circuit 31a, the voltage applied from the battery 4 can be varied in a plurality of levels for each of the first and second white color LEDs 60 and 61.

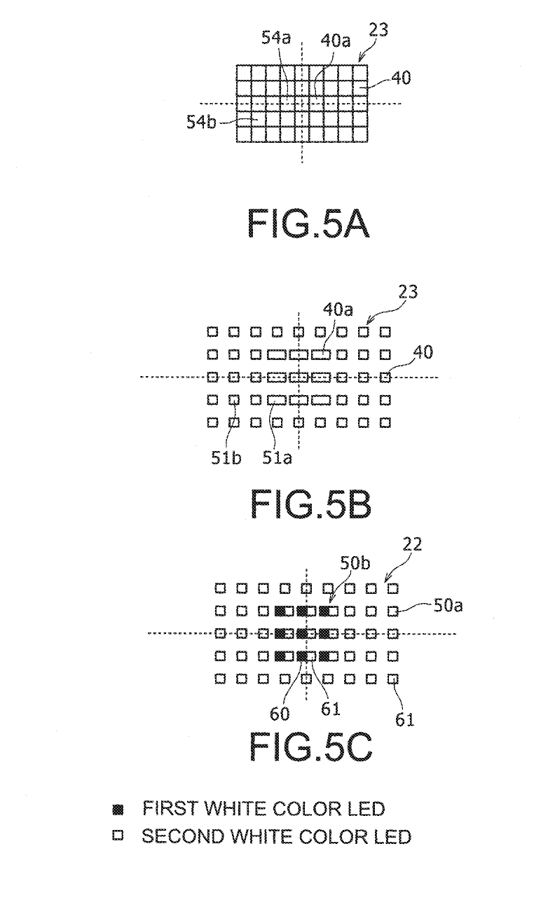

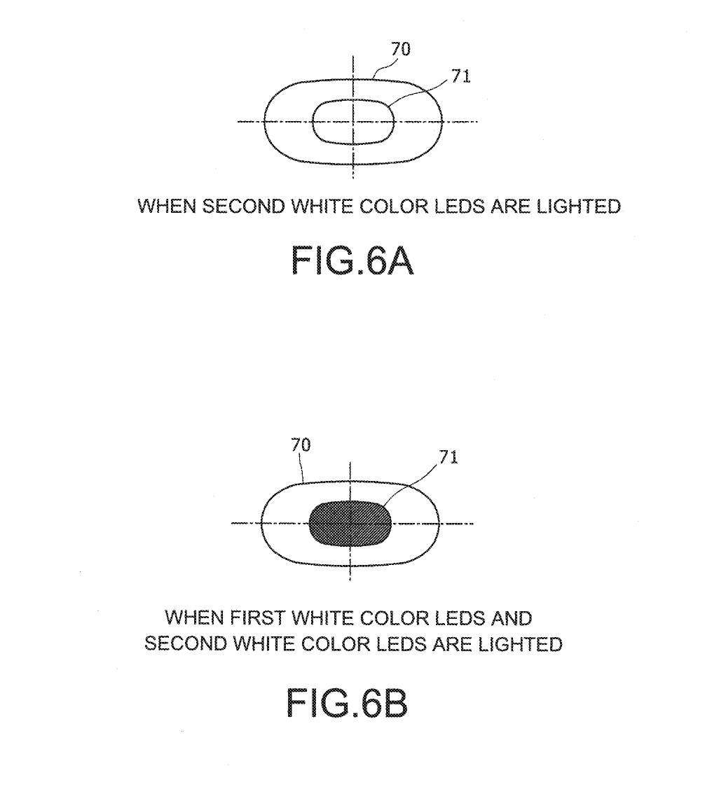

Next, with reference to FIGS. 5 to 8, there will be described example control using the signal from the camera 3 and the signal from the biometric information inputter 5, and example control which does not use these signals. FIGS. 5A-5C are diagrams showing a relationship between the light exit surface of the primary lens 23, the light incidence surface of the primary lens 23, and the light emission surface of the LED substrate 22. Specifically, FIG. 5A is a plan view showing the light exit surface of the primary lens 23 and FIG. 5B is a plan view showing the light incidence surface of the primary lens 23. FIG. 5C is a plan view showing the light emission surface of the LED substrate 22. FIGS. 6A and 6B are diagrams for explaining a chromaticity distribution at the headlight 2. Specifically, FIG. 6A shows a chromaticity distribution as viewed from a driver's seat when all of the second white color LEDs 61 included in the LED substrate 22 are lighted, and FIG. 6B shows a chromaticity distribution as viewed from the driver's seat when all of the first and second white color LEDs 60 and 61 included in the LED substrate 22 are lighted. In FIGS. 6A and 6B, a closed curve 70 shows an outer periphery of an illumination region of the headlight 2, and a closed curve 71 shows an outer periphery of an illumination region of the 9 group light sources 50b.

As shown in FIGS. 5B and 5C, a light incidence surface 51a of the light guide combiner 40a corresponding to the group light source 50b has an area which is approximately twice an area of a light incidence surface 51b of the light guide 40 corresponding to the single light source 50a. On the other hand, as shown in FIG. 5A, a light exit surface 54a of the light guide combiner 40a corresponding to the group light source 50b has an area which is approximately equal to an area of a light exit surface 54b of the light guide 40 corresponding to the single light source 50a. In the light guide combiner 40a, a cut surface perpendicular to a direction of progress of the light passing through the light guide combiner 40a is gradually reduced along the direction of progress of the light. As a result, the light of the bright white color and the light of the natural white color can be efficiently combined by the light guide combiner 40a.

In comparison to the case shown in FIG. 6A, in the case shown in FIG. 6B, the region surrounded by the closed curve 71 can be illuminated with light in which the light of the bright white color and the light of the natural white color are combined. Because of this, in the headlight 2, it is possible to illuminate the region surrounded by the closed curve 71 brighter and standing from the other regions with the light including the light of the bright white color. The region surrounded by the closed curve 71 forms a particular region which can be illuminated with the light of the bright white color which is the light of the first color.

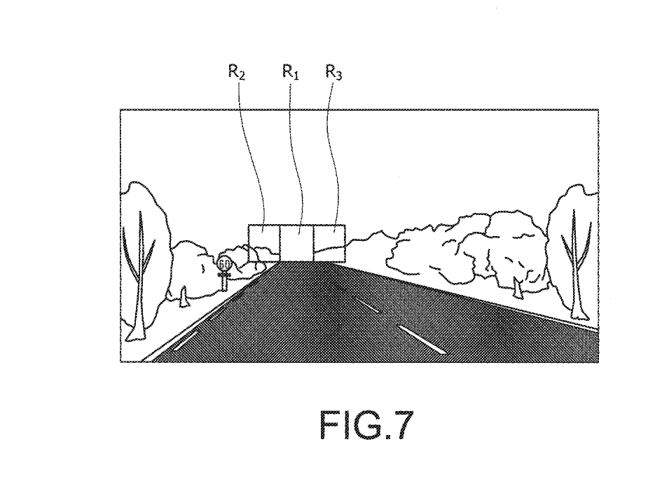

FIG. 7 is a diagram showing a front side of the automobile 1 as viewed from the driver's seat, and for explaining a reason why the accidents can be suppressed by the automobile 1. As described above with reference to FIG. 6, in the automobile 1, the particular region occupying the central portion of the illumination region can be illuminated brightly and standing from the other regions by the light including the light of the bright white color. Therefore, a region R1 on a road can be illuminated brightly and standing from side regions R2 and R3 of the road. Thus, the driver can more easily recognize an oncoming vehicle and a pedestrian crossing the road in the region R1, whereby contact and accident with the oncoming vehicle and the pedestrian can be suppressed.

With reference again to FIG. 4, when the driver of the automobile 1 inputs the age, presence or absence of cataract, and the stage of the cataract through the biometric information inputter 5, the controller 6 executes lighting control of the first white color LED 60 and the second white color LED 61 based on the signal including the biometric information from the biometric information inputter 5. In general, as a person ages, the sensitivity of light of the blue color which is of a short wavelength is reduced. Further, when a person is affected by the cataract, the sensitivity of light of the blue color is reduced as the stages of the disease progresses. The automobile 1 has, for example, a storage unit within or outside of the controller, and the storage unit stores a map correlating the age and the degree of the stage of the cataract, and the values of voltages to be applied to the first and second white color LEDs 60 and 61. The controller 6 specifies the voltage to be applied to the first and second white color LEDs 60 and 61 based on the signal including the biometric information and the map, and controls the switching units as described above, so that the specified voltages are applied to the first and second white color LEDs 60 and 61.

In one example configuration, the controller 6 increases the voltages to be applied to the first and second white color LEDs 60 and 61 as the age is increased or the cataract progresses. Further, as the age is increased or as the cataract progresses, the controller 6 applies a control to stepwise increase a ratio of the voltage applied to the first white color LED 60 which emits light of the bright white color with respect to the voltage applied to the second white color LED 61 which emits the light of the natural white color. Further, in another example configuration, the controller 6 does not change the voltage applied to the second white color LED 61 regardless of the signal including the biometric information, but applies a control to stepwise increase the voltage applied to the first white color LED 60 as the age is increased or as the cataract progresses.

A configuration has been described in which the automobile 1 has the biometric information inputter 5 which enables input of the age, presence or absence of cataract, and the stage of the cataract. Alternatively, the biometric information inputter may have a structure to allow input of only the age and the presence or absence of cataract. Alternatively, the biometric information inputter may have a structure to allow input of the age only. Alternatively, the movable body may have no biometric information inputter. In addition, a configuration has been described in which the voltage to be applied to each of the first and second white color LEDs 60 and 61 can be stepwise changed, but alternatively, the voltage applied to each light emitting element may be changeable in a continuous manner. Alternatively, the voltage applied to each light emitting element may be unchangeable. Further, a configuration has been described in which the controller 6 applies the control to stepwise change the voltages to be applied to the first and second white color LEDs 60 and 61 based on the signal from the biometric information inputter 5. Alternatively, a configuration may be employed in which the movable body has an operation unit which can continuously or stepwise change the voltage applied to at least one light emitting element, and the driver of the movable body or the like can change the voltage applied to the at least one light emitting element using the operation unit. Further, the region surrounded by the closed curve 71 may be illuminated with only the light of the bright white color from the first white color LED 60.

As described, the headlight 2 comprises the LED substrate 22 in which a plurality of the light sources 50 are mounted on the substrate 33, the primary lens 23 provided at the light emission side of the plurality of light sources 50, and the projector lens 24 placed at the opposite side from the side of the LED substrate 22 with respect to the primary lens 23. Further, the plurality of light sources 50 includes one or more group light sources 50b each including the first and second white color LEDs 60 and 61. Moreover, the primary lens 23 includes one or more light guide combiners 40a, each of which includes a light incidence surface 51a placed at a light emission side of the group light source 50b and a light exit surface 54a provided at an end on an opposite side from the light incidence surface 51a, and which guides the light of the bright white color and the light of the natural white color in a manner to allow combining of the lights. When the light of the bright white color is emitted from the group light source 50b, the light of the bright white color is emitted from the first color light emission region 52a of the light exit surface 52, and when the light of the natural white color is emitted from the group light source 50b, the light of the natural white color is emitted from the second color light emission region 52b of the light exit surface 52. The first color light emission region 52a and the second color light emission region 52b have portions which overlap each other.

According to the headlight 2 of the above-described embodiment, merely by simultaneously emitting the light of the bright white color and the light of the natural white color from the group light source 50b, the light of the bright white color and the light of the natural white color can be combined in the region surrounded by the closed curve 71 which is illuminated by the light from the group light source 50b, and the color toning can be executed easily and reliably. In addition, by merely adjusting the electric power supplied to the first white color LED 60 which emits the light of the bright white color and the electric power supplied to the second white color LED 60 which emits the light of the natural white color, the intensity of the light of the bright white color and the intensity of the light of the natural white color can be easily adjusted, and thus, the degree of freedom of color toning is high. Further, because the light of the bright white color and the light of the natural white color are combined in the same light guide combiner 40a, the color toning unevenness can be suppressed as compared to the case where the light of the bright white color and the light of the natural white color are toned without the use of the light guide combiner.

In addition, the headlight 2 may include the controller 6 which can independently control the plurality of first and second white color LEDs 60 and 61. The controller 6 may be configured to selectively drive the first white color LED 60 which emits the light of the bright white color, of the first and second white color LEDs 60 and 61 included in each of one or more particular group light sources 50b. Alternatively, the region illuminated by the light of the bright white color emitted from the first white color LED 60 included in each of the one or more particular group light sources 50b may be unevenly distributed in the region surrounded by the closed curve 71 which is a partial region of the illuminable region of the headlight 2.

According to such a configuration, the region surrounded by the closed curve 71 which is the particular region can be illuminated with light of a color different from that of the other regions. Therefore, a marking illumination can be realized in which the particular region is illuminated distinctively and standing from the other regions.

Moreover, in the headlight 2, each group light source 50b may include the first and second white color LEDs 60 and 61 which emit light of the bright white color and light of the natural white color of a plurality of color temperatures which differ from each other.

According to such a configuration, white color light to be illuminated can be changed according to the visual power of the driver. For example, the light to be illuminated may be changed to white color light having a high spectral intensity for the light of a short wavelength such as the blue color light, for old people and people affected by the cataract. Therefore, it is possible to suppress worsening of the visual field based on the visual power of the driver, and the accidents during driving can be suppressed.

In addition, the automobile 1 may include the controller 6 which is configured to individually control the plurality of first and second white color LEDs 60 and 61, and the biometric information inputter 5 for inputting the biometric information of the driver, and the controller 6 may drive and control the one or more group light sources 50b based on the signal from the biometric information inputter 5.

According to such a configuration, the light to be illuminated can be changed based on the signal including the biometric information from the biometric information inputter 5. When the driver is an old person or is affected by the cataract, the light emitted from the headlight 2 can be changed to light having a high spectrum intensity for the light of the short wavelength such as the blue color light in at least a part of the illumination region. Thus, it is possible to suppress worsening of the visual field based on the visual power of the driver, and to suppress the accidents during driving.

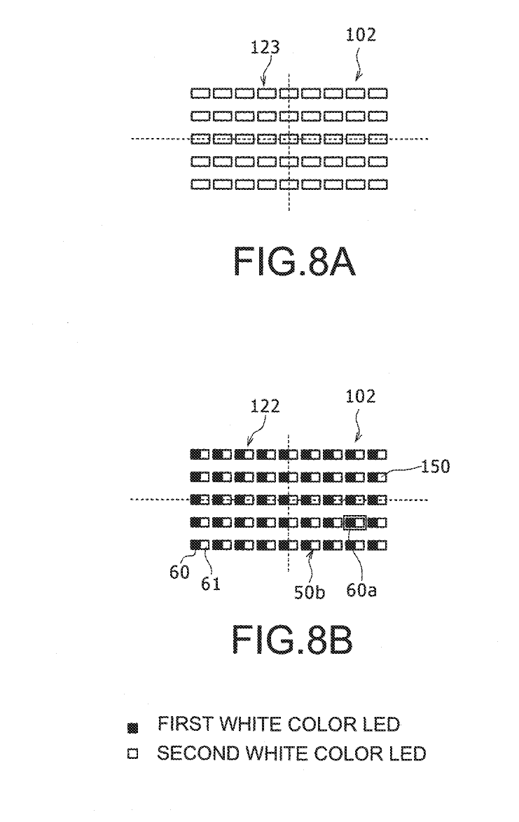

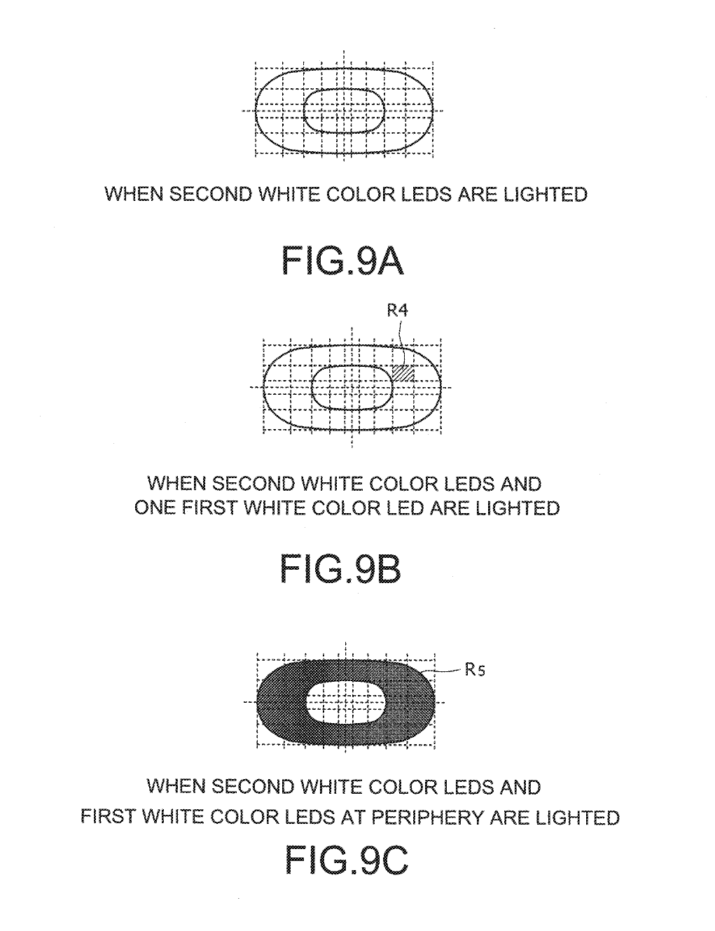

Next, with reference to FIGS. 7 to 9, there will be described a headlight 102 of an alternative configuration having a higher degree of freedom of the light distribution, and control of the headlight 102 using information from the camera 3. FIGS. 8A and 8B are diagrams showing a relationship between a light incidence surface of a primary lens 123 and a light emission surface of an LED substrate 122 in the headlight 102 of the alternative configuration. Specifically, FIG. 8A is a plan view showing the light incidence surface of the primary lens 123, and FIG. 8B is a plan view of the light emission surface of the LED substrate 122. FIGS. 9A-9C are diagrams for explaining the chromaticity distribution in the headlight 102 of the alternative configuration. Specifically, FIG. 9A is a diagram showing a chromaticity distribution as viewed from the driver's seat when all of the second white color LEDs 61 included in the LED substrate 122 are lighted. FIG. 9B is a diagram showing a chromaticity distribution as viewed from the driver's seat when all of the second white color LEDs 61 and one first white color LED 60 are lighted. FIG. 9C is a diagram showing a chromaticity distribution as viewed from the driver's seat when all of the second white color LEDs 61 and only the first white color LEDs 60 positioned at a periphery of the LED substrate 122 are lighted.

As shown in FIG. 8B, in the headlight 102 of the alternative configuration, all of light sources 150 placed in 5 rows and 9 columns are group light sources 50b, and each light source 150 includes the first white color LED 60 which emits light of the bright white color which is the first color, and the second white color LED 61 which emits light of the natural white color which is the second color. The headlight 102 of the alternative configuration differs from the headlight 2 in that all of the light sources 150 placed in 5 rows and 9 columns are group light sources 50b, and in the structures that must be changed as a consequence of this structural difference, and is similar to the headlight 2 in the other structures. For example, similar to the headlight 2, in the headlight 102 of the alternative configuration, the first and second white color LEDs 60 and 61 are independently driven and controlled with respect to the other first and second white color LEDs 60 and 61, by means of the controller.

With reference to FIGS. 8B and 9B, a case is considered in which a first white color LED 60a of the group light source 50b provided at a second column from the right and a second row from the bottom on the page of FIG. 8B, viewing the light emission surface of the LED substrate 122 from the front side, is lighted. In this case, a region R4 positioned at an upper right side on the page of FIG. 9B as viewed from the driver's seat is illuminated with the bright white light from the first white color LED 60. In the headlight 102, all of the light sources 150 are group light sources, and the first and second white color LEDs 60 and 61 are independently driven and controlled with respect to the other first and second white color LEDs 60 and 61 by means of the controller. Thus, a desired local region in the drawing as viewed from the driver's seat can be illuminated by one of the light of the bright white color, the light of the natural white color, and the combined light in which these lights are combined, and can be illuminated by a desired light. As a result, the degree of freedom of the light distribution can be significantly increased.

With reference to FIG. 9C, an example light distribution will be described. A case is considered in which all of the second white color LEDs 61 and the first white color LEDs 60 positioned at the periphery of the LED substrate 122 are lighted. In this case, when viewed from the driver's seat, a peripheral region R5 surrounding the central portion is illuminated with light including the light of the bright white color, and the peripheral region R5 can be shown brightly and standing from the other regions.

Therefore, in this case, with reference to FIG. 7, side regions R2 and R3 of the road which are more difficult to be seen than the region RI on the road can be shown brightly and standing from the other regions. Thus, it becomes possible to more easily view a pedestrian or the like present in the side regions R2 and R3 of the road who is to move out from the roadside, and the contact accident with the pedestrian or the like can be significantly reduced.

In the headlight 102 of the alternative configuration, a desired local region can be illuminated with a desired light, and the degree of freedom of light distribution is high. Therefore, information from the camera 3 can be more effectively used. For example, upon reception of a signal from the camera 3, the controller identifies a region in which the pedestrian, which is one example of a sensing target, is present in the illumination region. The controller then drives the first white color LED 60 of the group light source 50b corresponding to a lower side of the region in which the pedestrian is present, to illuminate a region at the feet of the pedestrian with bright light, standing from other regions. With such a configuration, not only is it easier for the driver to notice the pedestrian, but it is also possible to alert the pedestrian that the vehicle is approaching, and thus, the contact accident between the automobile and the pedestrian can be significantly reduced. In the headlight system of the alternative configuration, a human-sensing sensor which can sense a person and which outputs a signal to the controller is the camera 3, but alternatively, the human-sensing sensor may be formed with an infrared sensor or an image sensor other than the camera.

As described above in the alternative configuration with reference to FIGS. 8 and 9, a particular region which is a partial region of the illuminable region may be the peripheral region R5 positioned at the periphery of the illuminable region.

According to such a configuration, for example, the side regions R2 and R3 of the road which are more difficult to be viewed than the region R1 on the road can be shown brightly, and it becomes easier for the driver to see the pedestrian or the like who is to move out from the roadside. Thus, the contact accident with the pedestrian or the like can be significantly reduced.

Alternatively, the headlight system may include the headlight 102. The headlight 102 may comprise a controller which can individually control the plurality of the first and second white color LEDs 60 and 61. Further, the controller may be able to selectively drive the first white color LED 60 which emits the light of the bright white color, of the plurality of first and second white color LEDs included in each of one or more particular group light sources 50b. Moreover, the region illuminated by the light of the bright white color emitted from the first white color LED 60 included in each of the one or more particular group light sources 50b may be unevenly distributed in the particular region which is a particular partial region of the illuminable region. Alternatively, the headlight system may include the camera 3 which can sense people and which outputs a signal to the controller. Further, the controller may drive and control one or more group light sources 50b to match the particular region to the lower side region of the pedestrian sensed by the camera 3.

According to such a configuration, a region at the feet of the pedestrian can be illuminated with bright light, standing from the other regions. Therefore, as described above, not only is it easier for the driver to notice the pedestrian, but also, it is possible to alert the pedestrian that the vehicle is approaching, and the contact accident between the automobile and the pedestrian can be significantly reduced.

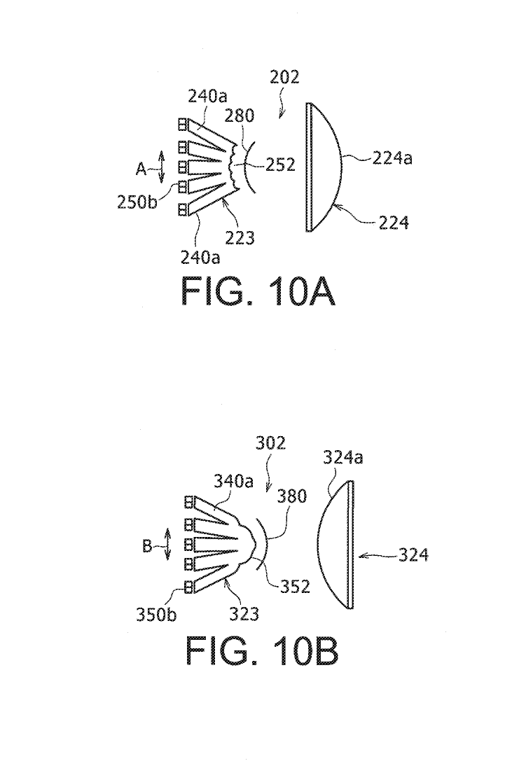

Next, with reference to FIGS. 10A and 10B, a desirable relative position of the light exit surface of the primary lens with respect to a focusing surface of the projector lens will be described. FIG. 10A is a diagram showing a relative position of a primary lens 223 with respect to a projector lens 224 in a headlight 202 of an alternative configuration. FIG. 10B is a diagram showing a relative position of a primary lens 323 with respect to a projector lens 324 in a headlight 302 of a further alternative configuration.

With reference to FIG. 10A, in the headlight 202 of the alternative configuration, the primary lens 223 includes a plurality of light guide combiners 240a. In addition, although not shown, the substrate has a rectangular front side surface, and a plurality of light sources are mounted on the substrate in a matrix form in such a manner that a row direction coincides with a longitudinal direction of the front side surface, and a column direction coincides with a width direction of the front side surface shown by an arrow A in FIG. 10A. A length of each light guide combiner 240a differs from a length of another light guide combiner 240a adjacent in the column direction to the light guide combiner 240a. Further, a light exit surface 252 of each light guide combiner 240a is curved, and the side of a group light source 250b is formed in a convex shape. In addition, a surface formed by light exit surfaces 252 of the plurality of the light guide combiners 240a at the side of the projector lens 224 is also curved and is formed in a convex shape on the side of the group light source 250b. Further, the projector lens 224 has a convex surface 224a on the side from which the light is emitted (right side of the page), and a focusing surface 280 of the projector lens 224 has a convex shape on the side of the group light source 250b. The light exit surface 252 is curved along the focusing surface 280 of the projector lens 224. Further, the focusing surface 280 of the projector lens 224 is placed near the light exit surface 252.

As shown in FIG. 10B, the headlight 302 of another alternative configuration comprises a plurality of light guide combiners 340a. Although not shown, the substrate has a rectangular front side surface, and a plurality of light sources are mounted on the substrate in a matrix form in such a manner that a row direction coincides with a longitudinal direction of the front side surface and the column direction coincides with a width direction of the front side surface shown by an arrow B in FIG. 10B. A length of the light guide combiner 340a differs from a length of another light guide combiner 340a adjacent in the column direction to the light guide combiner 340a. A light exit surface 352 of the light guide combiner 340a is curved, and the side of the projector lens 324 is formed in a convex shape. Further, a surface formed by the light exit surfaces 352 of the plurality of light guide combiners 340a on the side of the projector lens 324 is also curved, and the side of the projector lens 324 is formed in the convex shape. Moreover, the projector lens 324 has a convex surface 324a on the side of a group light source 350b (left side of the page), and a focusing surface 380 of the projector lens 324 is formed in a convex shape on the side of the projector lens 324. The light exit surface 352 is curved along the focusing surface 380 of the projector lens 324. The focusing surface 380 of the projector lens 324 is placed near the light exit surface 352.

As described in relation to the headlights 202 and 302 of the alternative configurations, the primary lenses 223 and 323 may include the plurality of light guide combiners 240a and 340a. In addition, the substrate may have a rectangular front side surface, and the plurality of light sources may be mounted on the substrate in a matrix form in such a manner that the row direction coincides with the longitudinal direction of the front side surface and the column direction coincides with the width direction of the front side surface. Further, the length of each light guide combiner 240a and 340a may differ from another light guide combiner 240a and 340a adjacent in the column direction to the light guide combiner 240a and 340a.

In this case, a distance between group light sources 250b and 350b adjacent in the column direction on the substrate can be elongated, which consequently facilitates mounting of the wiring or the like and manufacture of the light source substrate. In addition, because a distance between light emitting elements adjacent in the column direction can also be elongated, heat tends to not be confined in the light source substrate, and degradation of the light emitting element due to the heat can be suppressed.

As in the headlights 202 and 302 of the alternative configurations, the light exit surfaces 252 and 352 of the light guide combiners 240a and 340a may be curved.

In this case, it becomes easier to match the phases of the plurality of lights emitted from the headlights 202 and 302, and to consequently allow easier emission of distinctive light.

Further, as in the headlight 202 of the alternative configuration, the light exit surface 252 may have the side of the group light source 250b formed in a convex shape.

In this case, it becomes even easier to match the phases of the plurality of lights emitted from the headlight 202, and to facilitate emission of more distinctive light.

Moreover, as in the headlights 202 and 302 of the alternative configurations, the light exit surfaces 252 and 352 may be curved along the focusing surfaces 280 and 380 of the projector lenses 224 and 324.

In this case, it becomes easier to match the phases of the plurality of lights emitted from the headlights 202 and 302, and to facilitate emission of light with high distinctiveness.

In addition, as in the headlights 202 and 302 of the alternative configurations, the focusing surfaces 280 and 380 of the projector lenses 224 and 324 may be placed near the light exit surfaces 252 and 352.

In this case, it becomes even easier to match the phases of the plurality of lights emitted from the headlights 202 and 302, and to facilitate emission of light with a higher distinctiveness.

Desirable relative positions of the light exit surfaces of the primary lenses 223 and 323 with respect to the focusing surfaces 280 and 380 of the projector lenses 224 and 324 in two alternative configurations have been described. However, the shape of the projector lens, and the desirable relative position of the light exit surface of the primary lens with respect to the focusing surface of the projector lens are not limited to those shown in FIG. 10. For example, the projector lens may have both a one-side surface and the other-side surface formed in convex surfaces, or both the one-side surface and the other-side surface formed in concave surfaces. In this case also, desirably, the light exit surface of the light guide combiner is curved along the focusing surface of the projector lens.

The present disclosure is not limited to the above-described embodiment and the alternative configurations, and various improvements and modifications may be made within the items described in the claims and in the range of equivalence thereof.

For example, all of the light sources of the headlight may be group light sources, and each group light source may include a red light emitting element which emits light of red color, a green light emitting element which emits light of green color, and a blue light emitting element which emits light of blue color. The light emitting elements may be independently controllable from the other light emitting elements, and the voltages applied to the light emitting elements included in the group light source may be changed in a continuous manner. More specifically, each light source may include the red light emitting element which emits light of red color, the green light emitting element which emits light of green color, and the blue light emitting element which emits light of blue color. Each light source may be independently controllable from the other light sources, and in each light source, the red light emitting element, the green light emitting element, and the blue light emitting element may be independently controllable from the other light emitting elements. Further, each of the voltage applied to the red light emitting element, the voltage applied to the green light emitting element, and the voltage applied to the blue light emitting element may be changed in a continuous manner. In this case, in each group light source, the voltage applied to the red light emitting element, the voltage applied to the green light emitting element, and the voltage applied to the blue light emitting element may be suitably adjusted so that light of all color regions of the visible light can be emitted from the group light source. Therefore, a desired region may be illuminated with a desired color.

In addition, in the above-described embodiment, a case is described in which the light emitted from the light source 50 is visible light. Alternatively, the light emitted from the light source may include one or more lights which are not visible light. For example, in an automatically driven vehicle, because it is not necessary for a human to drive, the light emitted from the light source does not need to be visible light. Therefore, the light emitted from the light source may be any light with which the human-sensing sensor which can sense people and which outputs a signal to the controller, for example, a camera, can identify people and objects. The light emitted from the light source may include ultraviolet light, infrared light, or the like.

Further, in the above-described embodiment, a method is described in which the brightness of the light emitted from the light emitting element is controlled by changing the voltage applied to the light emitting element. Alternatively, the brightness of the light emitted from the light emitting element may be controlled by controlling the current supplied to the light emitting element. For example, in place of the control to change in a continuous manner the voltages applied to the light emitting elements, there may be applied a control which changes in a continuous manner the currents supplied to the light emitting elements. More specifically, the illumination device may comprise a current detector which detects a current flowing in the light emitting element. The controller receiving a signal from the current detector may then adjust a pulse width modulation signal which is output from outside to a light emitting element driver IC (for example, LED driver IC), to execute dimming (adjustment of brightness of the light emitting element). In this manner, the dimming may be realized by controlling the current supplied to the light emitting element in a pulse width modulation (PWM) dimming scheme. Alternatively, the controller receiving the signal from the current detector may change the voltage supplied from the outside in an analog manner using a variable resistor or the like, to change the amount of current supplied to the light emitting element, and consequently realize dimming In this manner, the current supplied to the light emitting element may be controlled in an analog dimming scheme, to realize the dimming Alternatively, the dimming may be executed by changing the amount of current supplied to the light emitting element with other schemes, for example, a phase dimming scheme. The dimming of the light emitting elements may be independently executed by appropriately changing the current supplied to the light source substrate by these schemes, and the dimming of the light emitting element may be executed in association with one or more other light emitting elements.

In addition, a configuration is described in which the movable body is an automobile. However, it is sufficient that the movable body is a means of transport, and may be, for example, a vehicle other than an automobile, such as a ship, an airplane, or the like. Further, a case is described in which the illumination device is the headlight 2, or 102, but alternatively, the illumination device may be equipped on facilities and machines other than the means of transport.

What is claimed is:

1. An illumination device comprising:
a substrate on which a plurality of light sources are mounted;
a light guide provided at a light emission side of the plurality of light sources; and
a projector lens provided at a side opposite of the substrate with respect to the light guide, wherein
the plurality of light sources includes one or more group light sources each including a first light color emitting element and a second light color emitting element,
the light guide includes one or more light guide combiners, each of which includes a light incidence surface provided at a light emission side of the group light source and a light exit surface provided at an end on a side opposite from the light incidence surface, and each of which guides the lights of the plurality of colors in a manner to allow combining of the lights, and
a first color light emission region of the light exit surface from which light of a first color is emitted and a second color light emission region of the light exit surface from which light of a second color is emitted overlap each other.

2. The illumination device according to claim 1, further comprising:
a controller which can individually control a plurality of light emitting elements, wherein
the controller is configured to selectively drive the first light color emitting element which emits the light of the first color among the plurality of light emitting elements included in each of one or more particular group light sources, and
a region illuminated by the light of the first color emitted from the first light color emitting element included in each of the one or more particular group light sources is unevenly distributed in a particular region which is a partial region of an illuminable region of the illumination device.

3. The illumination device according to claim 2, wherein the particular region is in a peripheral region positioned at a periphery of the illuminable region.

4. The illumination device according to claim 1, wherein
each of the group light sources includes a plurality of white light emitting elements which emit white color lights of a plurality of color temperatures which differ from each other.

5. The illumination device according to claim 1, wherein
the light guide includes a plurality of the light guide combiners,
the light source substrate has a rectangular front side surface,
the plurality of light sources are mounted on the light source substrate in a matrix form in such a manner that a row direction coincides with a longitudinal direction of the front side surface and a column direction coincides with a width direction of the front side surface, and
a length of the light guide combiner differs from a length of another light guide combiner adjacent in the column direction to the light guide combiner.

6. The illumination device according to claim 1, wherein
the light exit surface is curved.

7. The illumination device according to claim 6, wherein
the light exit surface has a convex shape on the side of the group light source.

8. The illumination device according to claim 6, wherein
the light exit surface is curved along a focusing surface of the projector lens.

9. The illumination device according to claim 6, wherein a focusing surface of the projector lens is placed near the light exit surface.

10. The illumination device according to claim 1, wherein
in the light guide combiner, a cut surface perpendicular to a direction of progress of the light passing through the light guide combiner is gradually reduced along the direction of progress of the light.

11. The illumination device according to claim 2, wherein
each of the light sources includes a red light emitting element which emits light of red color, a green light emitting element which emits light of green color, and a blue light emitting element which emits light of blue color, and
each of the light sources is independently controlled by the controller, and, in each light source, the red light emitting element, the green light emitting element, and the blue light emitting element are independently controlled by the controller, and
a voltage applied to or a current supplied to the red light emitting element, a voltage applied to or a current supplied to the green light emitting element, and a voltage applied to or a current supplied to the blue light emitting element are changeable in a continuous manner.

12. An illumination system comprising:
a light source substrate on which a plurality of light sources are mounted;
a light guide provided at a light emission side of the plurality of light sources;
a projector lens provided at a side opposite of the light source substrate with respect to the light guide;
a controller which can individually control a plurality of light emitting elements; and
a human-sensing sensor which can sense people and which outputs a signal to the controller, wherein
the plurality of light sources includes one or more group light sources each including a first light color emitting element and a second light color emitting element,
the light guide includes one or more light guide combiners, each of which includes a light incidence surface provided at a light emission side of the group light source and a light exit surface provided at an end on a side opposite from the light incidence surface, and each of which guides the lights of the plurality of colors in a manner to allow combining of the lights,
a first color light emission region of the light exit surface from which light of a first color is emitted and a second color light emission region of the light exit surface from which light of a second color is emitted overlap each other,
the controller is configured to selectively drive the first light emitting color element which emits the light of the first color among the plurality of light emitting elements included in each of one or more particular group light sources,
a region illuminated by the light of the first color emitted from the first light emitting element included in each of the one or more particular group light sources is unevenly distributed in a particular region which is a partial region of an illuminable region of the illumination device, and
the controller drives and controls the one or more group light sources to match the particular region with a lower side region of a target sensed by the human-sensing sensor.

13. A movable body comprising:
the illumination device according to claim 1.

14. The movable body according to claim 13, further comprising:
a controller which is configured to individually control a plurality of light emitting elements included in each of one or more particular group light sources; and
an inputter for inputting biometric information of a driver, wherein
the controller drives and controls the one or more group light sources based on a signal from the inputter.

15. The movable body according to claim 14, wherein
the biometric information includes at least one of age, presence or absence of cataract, and a stage of the cataract.
